(19) United States
(12) Patent Application Publication
(10) Pub. No.: US 2018/0045810 A1
(43) Pub. Date: Feb. 15, 2018

(54) METHOD AND DEVICE FOR PROCESSING RADAR SIGNALS

(71) Applicant: Infineon Technologies AG, Neubiberg (DE)

(72) Inventors: Romain YGNACE, Brunnthal (DE); Andre ROGER, Munchen (DE)

(21) Appl. No.: 15/648,495

(22) Filed: Jul. 13, 2017

(30) Foreign Application Priority Data
Aug. 12, 2016 (DE) 102016115040.1

(51) Int. Cl. G01S 7/288; G01S 7/292

(52) U.S. Cl. CPC G01S 7/288; G01S 7/2927; G01S 13/582

(57) ABSTRACT

A method is suggested for processing radar signals in a processing stage, the method comprising: (i) determining FFT results at a first precision, and (ii) storing a first group of the FFT results at a second precision, wherein the second precision is lower than the first precision. Also, a device and a computer program are provided accordingly.

### RELATED APPLICATION

This application claims priority under 35 U.S.C. § 119 to German Patent Application No. 102016115040.1, filed on Aug. 12, 2016, the content of which is incorporated by reference herein in its entirety.

### TECHNICAL FIELD

Embodiments of the present invention relate to radar applications, in particular an efficient way to process radar signals obtained by at least one radar sensor, e.g., via at least one antenna. Processing radar signals in this regard in particular refers to radar signals received by a sensor or an antenna.

### BACKGROUND

Several radar variants are used in cars for various applications. For example, radar can be used for blind spot detection (parking assistant, pedestrian protection, cross traffic), collision mitigation, lane change assist and adaptive cruise control. Numerous use case scenarios for radar appliances may be directed to different directions (e.g., back, side, front), varying angles (e.g., azimuth direction angle) and/or different distances (short, medium or long range). For example, an adaptive cruise control may utilize an azimuth direction angle amounting to ±18 degrees, the radar signal is emitted from the front of the car, which allows a detection range up to several hundred meters.

A radar source emits a signal and a sensor detects a returned signal. A frequency shift between the emitted signal and the detected signal (based on, e.g., a moving car emitting the radar signal) can be used to obtain information based on the reflection of the emitted signal. Front-end processing of the signal obtained by the sensor may comprise a Fast Fourier Transform (FFT), which may result in a signal spectrum, i.e. a signal distributed across the frequency. The amplitude of the signal may indicate an amount of echo, wherein a peak may represent a target that needs to be detected and used for further processing, e.g., adjust the speed of the car based on another car travelling in front.

### SUMMARY

A first embodiment relates to a method for processing radar signals in a processing stage the method comprising:
determining FFT results at a first precision,
storing a first group of the FFT results at a second precision, wherein the second precision is lower than the first precision.

A second embodiment relates to a device for processing radar signals comprising a FFT processing unit and a memory, wherein the FFT processing unit is arranged
for determining FFT results at a first precision;
for storing a first group of the FFT results at second precision in the memory, wherein the second precision is lower than the first precision.

A third embodiment is directed to a computer program product directly loadable into a memory of a digital processing device, comprising software code portions for performing the steps of the method described herein.

### BRIEF DESCRIPTION OF THE DRAWINGS

Embodiments are shown and illustrated with reference to the drawings. The drawings serve to illustrate the basic principle, so that only aspects necessary for understanding the basic principle are illustrated. The drawings are not to scale. In the drawings the same reference characters denote like features.

FIG. 1 shows a schematic diagram comprising an exemplary radar system emitting radar signals and receiving returned radar signals, wherein the radar system determines a range, a velocity and an azimuth angle;

FIG. 2 shows an exemplary processing stage comprising a direct memory access (DMA) input and a DMA output to access (read/write) a memory;

FIG. 3 shows an exemplary arrangement of an FFT processing path comprising an analog-to-digital converter, two FFT processing units and two memories, wherein the FFT processing stages provide a range information and a velocity information.

### DETAILED DESCRIPTION

In a radar processing environment, a radar source emits a signal and a sensor detects a returned signal. The returned signal may be acquired in a time domain by at least one antenna, in particular by several antennas. The returned signal may then be converted into the frequency domain by conducting a Fast Fourier Transform (FFT), which may result in a signal spectrum, i.e., a signal distributed across the frequency. Frequency peaks may be used to determine potential targets, e.g., along a moving direction of a vehicle.

A Discrete Fourier Transform (DFT) may be implemented in computers by numerical algorithms or dedicated hardware. Such implementation may employ FFT algorithms. Hence, the terms “FFT” and “DFT” may be used interchangeably.

Constant false alarm rejection (CFAR), also referred to as constant false alarm rate, is in particular known as a threshold method for FFT result analysis which may be based on a signal power. CFAR allows adapting a threshold to decide whether the FFT signal indicates a potential target. CFAR in particular considers background noise, clutter and interference. Several CFAR algorithms are known. For details, reference is made to a description of Constant False Alarm Rate in Wikipedia (e.g., see http://en.wikipedia.org/wiki/Constant_false_alarm_rate).

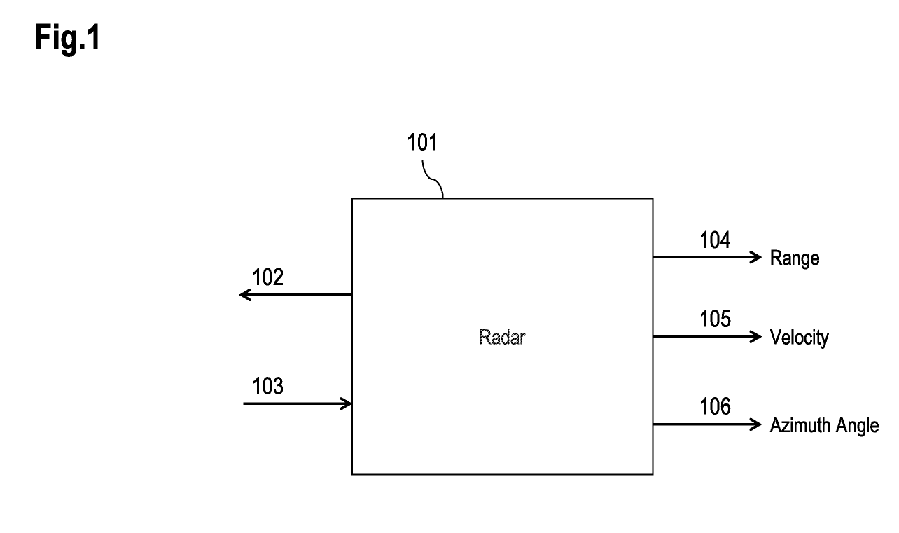

FIG. 1 shows a schematic diagram comprising an exemplary radar system 101 emitting radar signals 102 and receiving returned radar signals 103. The radar system 101 determines a range 104, a velocity 105 and an azimuth angle 106 based on the returned radar signals 103.

By using several receiving antennas, a phase difference of the received returned radar signals 103 may be used to determine the azimuth angle 106 via a third stage FFT. A first stage FFT based on the received returned (e.g., reflected emitted) radar signals 103 is used to determine the range 104, a second stage FFT based on the range 104 is used to determine the velocity 105 and the third stage FFT based on the velocity 105 is used to determine said azimuth angle 106.

In an exemplary scenario, the emitted radar signals 102 may be originated by two transmitter antennas towards an exemplary object. The signals 102 are reflected at the object and arrive at several (e.g., four) receiving antennas dependent on the azimuth angle with different phase position. Hence, the distances between the single object, the transmitter antennas and the receiver antennas may be deemed different.

FFT processing units (also referred to as FFT accelerators) are popular in automotive use cases. They are used to detect objects in front or behind a car. With an increasing demand of (semi-)autonomous driving there is a significant trend to equip cars with radar systems. The radar systems require a substantial amount of processing power. A higher efficiency for processing radar data may result in more effective radar systems and/or in more cost-efficient hardware, which may require less space and/or energy.

An FFT processing unit may use various data formats, e.g.:
a fixed point data format with 16 bits or with 32 bits, the latter being used for higher precision purposes;
a floating point data format with 16 bits or 32 bits.

Examples suggested herein are in particular directed to an architecture that copes with a reduced amount of processing resources or—having the same processing resources available—allows for an increased performance.

It is one exemplary objective in radar applications, in particular in automotive radar applications, to process data, store interim data and store data results. In exemplary scenarios, an internal processing system may utilize an existing bus system with a limited bandwidth and a processor (CPU) with limited processing capability. Increasing the efficiency of a radar processing approach leads to a significant benefit with regard to the overall performance of such system.

With the introduction of more complex FFT algorithms and with several FFT stages processed subsequently, existing solutions may either be limited to a low precision data format or more processing power would be needed which in return would increase the overall energy consumption and costs of the radar system.

According to one exemplary embodiment, an FFT processing unit is provided that may conduct internal computations utilizing a floating point data format with 32 bits. This FFT processing unit provides the flexibility to choose between 32 bits floating point and 16 bits floating point as input variables and/or output variables.

It is noted that 16 bits and 32 bits floating point are exemplary precisions. In general, the FFT accelerator may be arranged for processing data in a first precision and at the same time it may be supplied with input data in this first precision or in a second precision. The output data of the FFT accelerator can be provided in the first or in a third precision. The second precision and the third precision may each be a lower precision compared to the first precision. The second precision and the third precision may be identical or different from each other.

It is also an option that the FFT processing unit is capable of handling data formats in more than two or more than three precisions.

The FFT processing unit handles internal computation with the high precision (first precision in the example above). This allows having the full precision available (if need would be) and reduces the risk of losing accuracy within signal processing loops, e.g., FFT stages. High Precision may in particular refer to two aspects: an absolute precision (referring to a number of bits that represent a signal) or a dynamic range of the signal. A signal with 16 bit inputs has a better output precision after it has been processed by an FFT using 32 bit precision as the dynamic range permitted is significantly higher.

In addition, the approach provides a high flexibility with regard to pre-processing and post-processing capabilities. For example, a reduced precision of 16 bits floating point can be used as input and output data format. This results in a significant memory reduction (only half the memory size is required when using 16 bits instead of 32 bits floating point). In addition, the bandwidth on the bus system is also reduced, which further results in less power consumption and thus a higher energy efficiency.

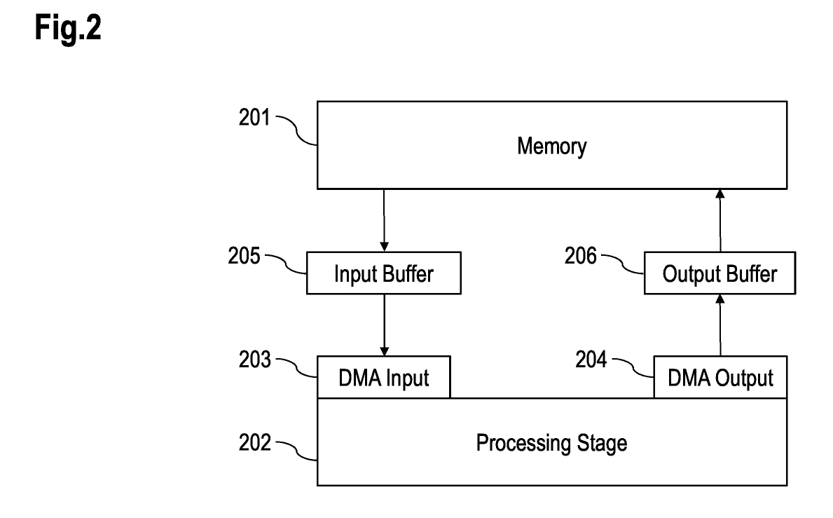

FIG. 2 shows an exemplary processing stage 202 (which may be or comprise an FFT processing unit, which is also referred to as FFT accelerator or FFT device). The processing stage 202 may comprise a DMA input 203 (DMA: direct memory access) and a DMA output 204 to access (read/write) a memory 201, which may be a radar memory.

The processing stage 202 may provide a decompression functionality via the DMA input 203 and a compression functionality via the DMA output 204.

The decompression functionality may convert an input data format to a processing data format, wherein the input or the processing data format may be a fixed point or a floating point data format. The input data format is of lower precision compared to the processing data format.

For example, the following adaptations or conversions may apply by the decompression: a fixed point data format with 16 bits to a fixed point data format with 32 bits or a floating point data format with 8 bits to a fixed point data format with 16 bits.

Accordingly, the compression functionality may produce a lower precision compared to the actual precision used by the processing stage, i.e., an output data format may have a reduced precision compared to the processing data format.

For example, the processing data format may be floating point 32 bits, whereas the input data format may be floating (or fixed) point 16 bits and the output data format may be floating (or fixed) point 16 bits.

Data is read via the DMA input 203 from the memory 201. The processing stage 202 uses the data to perform operations efficiently. The processing stage 202 may be arranged to conduct linear processing on a number of data. For example, the processing stage 202 may be an FFT processing stage that provides FFT results for a number of 256, 512 or 1024 samples.

It is noted that the processing stage 202 may be any of the following: a first FFT processing stage, a second FFT processing stage, a third FFT processing stage, a fourth FFT processing stage, a windowing stage, a beamforming stage, a processing stage providing coherent integration, a processing stage providing non-coherent integration, a processing stage conducting local maximum searches or a processing stage providing statistics.

It is further noted that at least one input buffer 205 may be provided between the memory 201 and the DMA input 203 and that at least one output buffer 206 may be provided between the DMA output 204 and the memory 201. As an option, the input buffer 205 may be part of the DMA input 203 or of the processing stage 202. Accordingly, the output buffer 206 may be part of the DMA output 204 or of the processing stage 202. The input buffer 205 and/or the output buffer 206 may also be provided as a separate memory/memories.

The results calculated at the processing stage 202 may be stored in any memory. It may be in particular an option to store the results at the location in the memory 201 from where the data to be processed into those results was read. In this case, at least one output buffer 206 may be provided which is filled by the processing stage 202. The DMA output 204 may thus write back the data from the output buffer 206 to the memory 201.

It is noted that both DMA input 203 and DMA output 204 may be combined providing a combined DMA (input and output) functionality.

It is further noted that the output of the processing stage 202 may be written to the same location (addresses) of the memory 201 from where the respective input was read. This may be efficient for radar applications, where, e.g., raw data are only required to compute first stage FFT data (then the raw data may never be used again): so the first stage FFT results are written over the raw data. This may apply for higher stage FFT computations accordingly. It is also an option, to not overwrite data in the memory 201, in particular to write results computed by the processing stage 202 to different addresses of the memory 201.

It is hence noted that the FFT processing unit may comprise the processing stage 202 with the DMA input 203, DMA output 204 and optionally the buffers 205, 206.

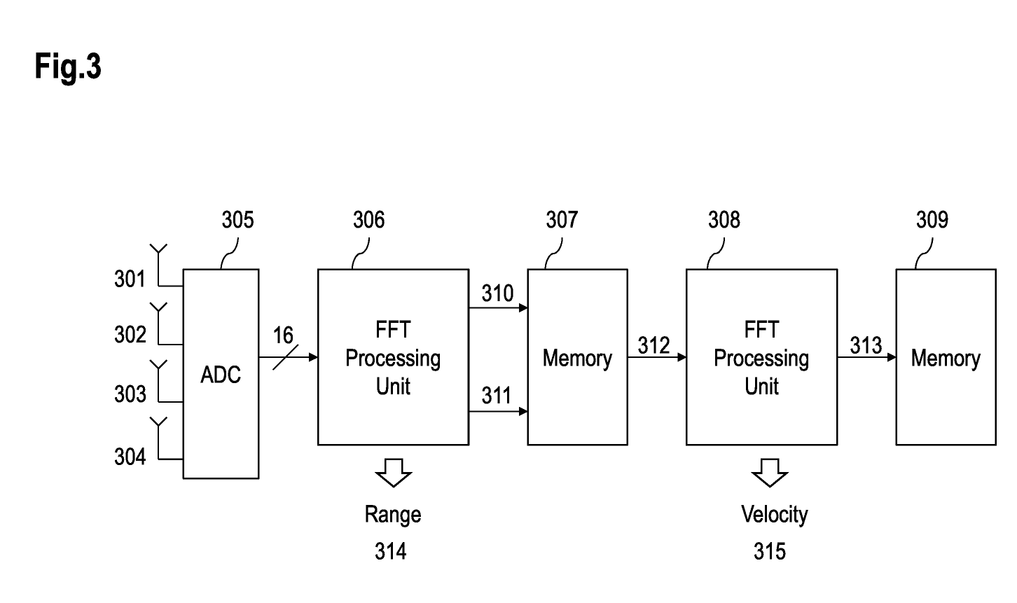

FIG. 3 shows an exemplary arrangement comprising an analog-to-digital converter ADC 305, which is connected to antennas 301 to 304. The antennas 301 to 304 receive reflections of an emitted radar signal. These reflections are sampled via the ADC 305 and conveyed as 16 bit values to a FFT processing unit 306.

The FFT processing unit 306 processes these sampled signals and determines a range information 314. FFT results (first stage FFT results) 310 are stored in a memory 307. The FFT results 310 may have a resolution (also referred to as precision) of 16 bits. In addition, the FFT processing unit 306 may determine peaks 311 (16 bit or 32 bit values) that are stored in the memory 307. Such peaks may be the result of threshold operations (e.g., CFAR) conducted by the FFT processing unit 306 in order to determine more relevant range information indicating objects at certain distances. The peaks 311 may be stored with a higher precision compared to the FFT results 310.

In a next stage FFT, the results of this FFT are further processed, which can then be done at a higher accuracy for such objects that already showed peaks in the range information. As the next FFT stage determines the velocity of such objects it is beneficial to have a higher precision available to also be able to provide better results with regard to the velocity information and potentially with regard to an azimuth angle in a subsequent third stage FFT.

A FFT processing unit 308 reads data 312 from the memory 307 and conducts a second stage FFT to determine a velocity information 315. The data 312 may comprise the results provided by the previous FFT processing unit 306, i.e. the FFT results 310 and the peaks 311. The FFT processing unit 308 may process values of 16 bits and/or values of 32 bits as read from the memory 307 or decompressed from the memory 307. The FFT processing unit 308 may comprise a threshold or filtering capability to supply FFT results 313 to a memory 309.

FIG. 3 exemplarily shows two FFT stages comprising the FFT processing unit 306 and the FFT processing unit 308. It is noted that these FFT processing units 306 and 308 may be realized by a single physical FFT processing unit that is used twice. Also, the memory 307 and the memory 309 may be the same physical memory. Hence the FFT processing unit conducts the first stage FFT determining the range information 314 and stores values, e.g., of different precision, in the memory. Then, the same FFT processing unit may read the values stored in the memory, optionally de-compresses these values to a higher precision, conduct the second stage FFT determining the velocity information 315 and stores values, e.g., of different precision in the same memory.

It is further noted that a third stage FFT may be applied by the same FFT processing unit to determine an azimuth angle information based on the values stored in the memory before.

According to an exemplary implementation, an FFT data path comprising the values stored in the memory and read from the memory as well as the respective FFT processing stage may operate on a precision of 32 bits floating point. The buffers 205, 206 shown in FIG. 2 may use the same data format of 32 bits floating point. The FFT processing stage 202 may conduct a data conversion (optional: decompression when reading data from the memory 201 via the input buffer 205; compression when writing data to the memory 201 via the output buffer 206). Such data conversion may be conducted on a single variable or on a set of variables. It is an option to use a wide bus as a memory interface.

It is also an option that values stored in the memory are converted by any processing entity.

It is an option that various compression and/or decompression mechanisms can be used, e.g.,
fixed or floating point: 16 bits input and 16 bits output;
fixed or floating point: 32 bits input and 16 bits output;
fixed or floating point: 16 bits input and 32 bits output;
fixed or floating point: 32 bits input and 32 bits output.

The conversion (compression or decompression) can be achieved by means of hardware and/or software.

Internal operation of the processing stage may support, e.g., 16 bits or 32 bits floating point operations.

Hence, it is an advantage that the processing stage is capable of providing internal operations on a precision of 32 bits floating point, whereas it is capable of handling 16 bits floating point as input values and it is able to supply 16 bits floating point as output values. Hence, floating point operations can be used in a flexible and memory-efficient way. This in particular applies if a clustering (filtering, thresholding) is conducted to identify values that are beneficially stored at a higher precision for a subsequent processing stage. It is in particular an advantage to (only) store those values at the higher precision that were identified by the clustering and to store other values with reduced precision.

The examples suggested herein may in particular be based on at least one of the following solutions. In particular combinations of the following features could be utilized in order to reach a desired result. The features of the method could be combined with any feature(s) of the device, apparatus or system or vice versa.

A method is provided for processing radar signals in a processing stage the method comprising:
determining FFT results at a first precision,
storing a first group of the FFT results at a second precision, wherein the second precision is lower than the first precision.

Hence, the FFT results are determined by a FFT processing unit, which may operate on floating point data format utilizing a first precision. The FFT processing unit provides a compression functionality by storing the first group of FFT results with a reduced precision, e.g., floating or fixed point.

The processing capability of, e.g., high precision (e.g., 32 bits) floating point may be used by the FFT processing unit, whereas data is at least partially stored at a reduced precision. The FFT processing unit is therefore fully flexible to cope with data formats of reduced precision.

This approach allows for a cost- and energy-efficient processing of FFT results.

In an embodiment, the radar signals comprise digitized data received by at least one radar antenna and determining the FFT results at a first precision based on the digitized data received.

In an embodiment, the method comprises:
storing a second group of the FFT results at the first precision.

In an embodiment, the second group of FFT results comprise FFT results that are based on a threshold or filtering operation.

It is in particular an option that only the first group of FFT results is stored with the second (reduced) precision and another second group of FFT results is stored with the first precision or with a precision that is between the second and the first precision. This second group of FFT results may be the result of a filtering, CFAR or threshold operation that indicates, e.g., objects which are subject to further processing (e.g., in a subsequent FFT stage).

In an embodiment, the method comprises:
reading values from a memory at a third precision, wherein the third precision is lower than or the same as the first precision,
determining the FFT results at a first precision based on the values read,
storing the first group of the FFT results at the second precision.

It is an option that the FFT processing unit obtains data (floating point or fixed point data format) with a third precision, which is equal to the first precision or lower than the first precision. In this regard, the FFT processing unit may provide a decompression functionality.

In an embodiment, the method comprises:
adjusting the second precision based on a stage of the FFT processing.

Hence, dependent on the actual FFT stage (e.g., first, second or third stage FFT), the second precision, i.e., the degree of compression, may be adjusted. For example, a first stage FFT may require a different degree of compression compared to a second stage FFT.

In an embodiment, the method comprises:
adjusting the second precision based on a predefined condition.

In an embodiment, the predefined condition comprises at least one of the following:
a weather condition;
a light condition;
a condition based on the environment;
a condition based on the surroundings;
a measurement cycle.

The second precision, i.e., the level of compression, can be adjusted dependent on various conditions or parameter. The result of recognizing objects may depend on, e.g., the weather or light conditions, which may in return result in an adjustment of the second precision utilized.

In an embodiment, the first precision is one of the following:
a fixed point data format with 16 bits;
a fixed point data format with 32 bits;
a floating point data format with 16 bits;
a floating point data format with 32 bits.

In an embodiment, the second precision is one of the following:
a fixed point data format with 8 bits;
a fixed point data format with 16 bits;
a floating point data format with 8 bits;
a floating point data format with 16 bits.

In an embodiment, the method further comprises:
conducting a multi-stage FFT, wherein each stage comprises:
   determining FFT results at a first precision,
   storing a first group of the FFT results at a second precision, wherein the second precision is lower than the first precision.

It is in particular an option that several FFT stages are subsequently processed by one FFT processing unit on at least one memory. In one example, three subsequent FFT stages may be used to determine the range, the velocity and the azimuth angle of an object, e.g., in front of a car or behind the car.

In an embodiment, the FFT results are first-stage FFT results, second-stage FFT results or third-stage FFT results.

In an embodiment, determining FFT results at a first precision is provided by a single device, in particular a single chip.

Also, a device is suggested for processing radar signals comprising a FFT processing unit and a memory, wherein the FFT processing unit is arranged
for determining FFT results at a first precision;
for storing a first group of the FFT results at second precision in the memory, wherein the second precision is lower than the first precision.

In an embodiment,
the radar signals comprise digitized data received by at least one radar antenna,
the FFT processing unit is arranged for determining the FFT results at a first precision based on the digitized data received.

In an embodiment, the FFT processing unit is arranged for storing a second group of the FFT results at the first precision.

In an embodiment, the second group of FFT results comprise FFT results that are based on a threshold or filtering operation.

In an embodiment, the FFT processing unit is arranged
for reading values from a memory at a third precision, wherein the third precision is lower than or the same as the first precision,
for determining the FFT results at a first precision based on the values read,
for storing the first group of the FFT results at the second precision.

Also, a computer program product is provided that is directly loadable into a memory of a digital processing device, comprising software code portions for performing the steps of the method as described herein.

In addition, the problem stated above is solved by a computer-readable medium, e.g., storage of any kind, having computer-executable instructions adapted to cause a computer system to perform the method as described herein.

In one or more examples, the functions described herein may be implemented at least partially in hardware, such as specific hardware components or a processor. More generally, the techniques may be implemented in hardware, processors, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium, i.e., a computer-readable transmission medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more central processing units (CPU), digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a single hardware unit or provided by a collection of interoperative hardware units, including one or more processors as described above, in conjunction with suitable software and/or firmware.

Although various exemplary embodiments of the invention have been disclosed, it will be apparent to those skilled in the art that various changes and modifications can be made which will achieve some of the advantages of the invention without departing from the spirit and scope of the invention. It will be obvious to those reasonably skilled in the art that other components performing the same functions may be suitably substituted. It should be mentioned that features explained with reference to a specific figure may be combined with features of other figures, even in those cases in which this has not explicitly been mentioned. Further, the methods of the invention may be achieved in either all software implementations, using the appropriate processor instructions, or in hybrid implementations that utilize a combination of hardware logic and software logic to achieve the same results. Such modifications to the inventive concept are intended to be covered by the appended claims.

1. A method for processing radar signals in a processing stage, the method comprising:
determining Fast Fourier Transform (FFT) results at a first precision, and
storing a first group of the FFT results at a second precision, wherein the second precision is lower than the first precision.

2. The method according to claim 1,
wherein the radar signals comprise digitized data received by at least one radar antenna and determining the FFT results at the first precision is based on the digitized data received.

3. The method according to claim 1, comprising:
storing a second group of the FFT results at the first precision.

4. The method according to claim 3, wherein the second group of the FFT results comprise FFT results that are based on a threshold or filtering operation.

5. The method according to claim 1, comprising:
reading values from a memory at a third precision, wherein the third precision is lower than or a same as the first precision,
determining the FFT results at the first precision based on the values read, and
storing the first group of the FFT results at the second precision.

6. The method according to claim 1, comprising:
adjusting the second precision based on a stage of processing the FFT.

7. The method according to claim 1, comprising:
adjusting the second precision based on a predefined condition.

8. The method according to claim 7, wherein the predefined condition comprises at least one of:
a weather condition;
a light condition;
a condition based on an environment;
a condition based on surroundings; or
a measurement cycle.

9. The method according to claim 1, wherein the first precision is one of:
a fixed point data format with 16 bits;
a fixed point data format with 32 bits;
a floating point data format with 16 bits; or
a floating point data format with 32 bits.

10. The method according to claim 1, wherein the second precision is one of:
a fixed point data format with 8 bits;
a fixed point data format with 16 bits;
a floating point data format with 8 bits; or
a floating point data format with 16 bits.

11. The method according to claim 1, further comprising:
conducting a multi-stage FFT, wherein each stage comprises:
the determining of the FFT results at the first precision, and
the storing of the first group of the FFT results at the second precision, wherein the second precision is lower than the first precision.

12. The method according to claim 1, wherein the FFT results are first-stage FFT results, second-stage FFT results, or third-stage FFT results.

13. The method according to claim 1, wherein the determining of the FFT results at the first precision is provided by a single chip.

14. A device for processing radar signals comprising:
a FFT processing unit, and
a memory,
wherein the FFT processing unit is arranged
for determining FFT results at a first precision; and
for storing a first group of the FFT results at a second precision in the memory, wherein the second precision is lower than the first precision.

15. The device according to claim 14,
wherein the radar signals comprise digitized data received by at least one radar antenna,
wherein the FFT processing unit is arranged for determining the FFT results at the first precision based on the digitized data received.

16. The device according to claim 14, wherein the FFT processing unit is arranged for storing a second group of the FFT results at the first precision.

17. The device according to claim 16, wherein the second group of the FFT results comprise FFT results that are based on a threshold or filtering operation.

18. The device according to claim 14, wherein the FFT processing unit is arranged
for reading values from a memory at a third precision, wherein the third precision is lower than or a same as the first precision,
for determining the FFT results at the first precision based on the values read,
for storing the first group of the FFT results at the second precision.

19. A computer program product directly loadable into a memory of a digital processing device, comprising software code portions for performing the method according to claim 1.
